(19) United States
(12) Patent Application Publication
(10) Pub. No.: US 2008/0296460 A1
(43) Pub. Date: Dec. 4, 2008

(54) CEILING MOUNTED BRACE FOR AN ELECTRICAL FIXTURE

(76) Inventor: Jack Russell Kerr, JR., College Station, TX (US)

Correspondence Address: BLANK ROME LLP, ONE LOGAN SQUARE, PHILADELPHIA, PA, 19103, US

(21) Appl. No.: 12/130,465

(22) Filed: May 30, 2008

Related U.S. Application Data
(60) Provisional application No. 60/940,805, filed on May 30, 2007.

(51) Int. Cl. F21S 8/04

(52) U.S. Cl. 248/343

(57) ABSTRACT

The invention is directed to a ceiling mounted brace bracket assembly for securing an electrical fixture. The brace of the invention includes a telescoping tubular bar mechanism for adjustment during installation and pre-set fastener openings to hold fasteners in place for “one-handed” installation. The design distributes the weight of the fixture to a specific component of the brace.

### CROSS-REFERENCE TO RELATED APPLICATIONS

This application claims the benefit of U.S. Provisional Application Ser. No. 60/940,805 filed May 30, 2007, entitled “Ceiling Mounted Brace for an Electrical Fixture,” which is incorporated herein by reference.

### FIELD OF THE INVENTION

This invention relates to a mounting device for an electrical fixture. In particular, the invention is a brace for mounting an electrical fixture in a ceiling.

### BACKGROUND OF THE INVENTION

An electrical junction box provides a safe enclosure for the electrical wiring that powers an electrical device. For an electrical device hanging from a ceiling, such as a ceiling fan or light fixture, the electrical junction box typically spans between two spaced beams, joists, studs, or the like. A mounting bracket assembly provides the support necessary to suspend the electrical junction box between the two spaced beams, joists, studs, or the like. Alternatively, the electrical junction box may attach directly to a beam or joist or a cross-member between two beams or joists. In this case, the electrical junction box must provide the support necessary to suspend the electrical device from the ceiling.

The installation of a ceiling fan or light fixture can be an awkward and cumbersome task, especially when performed by a single individual. Often, the installer must work atop a ladder and may not have both hands free to perform the task. A mounting bracket assembly can improve the task of installation of a fixture by making the process easier, more convenient, thereby saving time and expense.

There is a demand for a mounting bracket assembly that provides greater strength, telescopes to accommodate a span between 14 and 26 inches between two spaced beams, joists, studs, or the like, and makes the installation process easier. Consumers have a strong interest in new installation projects due to new home construction, the renovation of existing homes, and additional choices in the selection of electrical lighting and fan fixtures in the marketplace. Likewise, consumers have a strong interest in doing these renovations on their own, rather than hiring a contractor, to save money. The presently disclosed ceiling mounted brace for an electrical fixture satisfies these demands.

### SUMMARY OF THE INVENTION

In a first embodiment, the invention is directed to a ceiling mounted brace bracket assembly means for securing an electrical fixture. The assembly means includes an electrical current connecting means and a spacer means secured to the electrical current connecting means. An adjusting means contacts the spacer means and a securing means is attached to the adjusting means. A means for holding a bracket fastening means is included on the securing means for attachment to a support structure by a bracket fastening means for securing the bracket assembly means to a support structure. The bracket fastening means for securing the bracket assembly means to a structure is held in position by the means for holding a bracket fastener prior to securing to a support structure.

In another embodiment, the invention is directed to a ceiling mounted brace bracket assembly for securing an electrical fixture. The bracket includes a telescoping tubular bar mechanism and an electrical junction box having an inner surface and an outer surface, wherein the box is attached to the telescoping tubular bar mechanism. End plates are attached at each end of the telescoping tubular bar mechanism. The telescoping tubular bar mechanism includes an inner member having a first end and a second end, and an outer member having a first end and a second end, wherein the diameter of the inner member is smaller than the diameter of the outer member, wherein the inner member slides inside the outer member upon attachment.

The bracket further includes a clamping mechanism attached to the electrical box, wherein the clamping mechanism includes a longitudinal spacer member having a first surface and a second surface having inlets therethrough. The spacer extends along a mid-line of the outer surface of the electrical box. The clamping member further includes at least one threaded member, wherein the threaded member includes a flange and protruding boss. The protruding boss has an interior and exterior surface, wherein the interior surface has threads which extend the length thereof. The spacer is substantially rectangular in shape having a width and a length, wherein the flange of the at least one threaded member extends outside the width of the spacer. The protruding boss of the at least one threaded member traverses the spacer and the inner and outer surface of the electrical box, wherein a first surface of the flange of the at least one threaded member is in contact with the inner member of the telescoping bar.

The bracket further includes boss fasteners that contact the inner surface of the upper wall of the electrical box. The first end of the inner member and the first end of the outer member of the telescoping tubular bar mechanism are attached to an end-plate. The end-plate includes a body section, a joist tab at a lower edge, and fastener tabs on a first side of the end-plate body and a second side of the end-plate body, wherein the fastener tabs have openings. The joist tab is perpendicular to the end-plate body and the fastener tabs are parallel to the end-plate body. In this embodiment, the fastener tabs are U-shaped forming a first portion and a second portion, wherein the first portion of the U-shaped tab includes a first opening that is horizontally aligned with a second opening in the second portion of the U-shaped tab. The diameter of the first opening is such that it will hold a fastener in place prior to installation. In this embodiment, the first portion and the second portion of the U-shaped fastener tab are of equal length.

In a variation of the embodiment, the fastener tabs of the end-plate are planar having a central opening for placement of the fasteners. In this variation, the bracket can include an overlay positioned proximal to the end-plate. The overlay will include a cutout in a midsection, wherein the overlay includes a tab on the left and right side of the cutout. Each tab includes an upper and lower finger, wherein each finger includes a semicircular cutout aligned with the opening in the fastener tabs of the end-plate, wherein the fingers pivot along a horizontal line through the tab. The tab includes a hinge cutout on the inner portion of the tab proximal to the cutout.

Further, in this variation of the end-plate, the bracket can include a shoulder washer having a flange and a protruding boss, wherein the protruding boss has a diameter complimentary to the opening in the end-plate fastener tabs. The flange of the shoulder washer will contact the end-plate fastener tabs when the protruding boss is inserted into the opening in the end-plate fastener tabs. The protruding boss has an opening through its center and along a lateral axis, wherein the diameter of the opening through the boss is appropriate to hold a fastener in a preset position prior to installation.

A core concept of the shoulder washer is the ability to hold a fastener in place prior to installation. Therefore, it is recognized that the shoulder washer can be used to install the electrical box directly to a beam, joist or a cross-member between two beams or joists, without the necessity of the clamping mechanism, telescoping bar mechanism or end-plates.

In another embodiment, a ceiling mounted brace assembly includes a shoulder washer having a flange portion and a protruding boss portion. The shoulder washer is designed to hold a fastener in a preset position. The ceiling mounted brace further includes an electrical junction box having an inner surface and an outer surface, wherein the inner surface has an inner wall area and the outer surface has an outer wall area. The flange of the shoulder washer is in contact with the inner wall area and the protruding boss is flush with the outer wall area of the electrical box. During installation, the protruding boss expands upon being traversed by a fastener further securing the electrical box.

In another embodiment, the invention is directed to a method for installing a ceiling mounted brace for an electrical fixture. The method includes the steps of (a) assembling a bracket assembly by; (i.) attaching a substantially rectangular spacer member having a defined width and length, to an electrical box, wherein the spacer member is attached by at least one threaded member which traverses the end-plate and the electrical box. The threaded member includes a flange and protruding member, wherein the flange extends beyond the width of the spacer member. Thereafter, assembly of the bracket continues by; (ii.) contacting the flange of the threaded member to a telescoping tubular member, wherein the telescoping tubular member has an inner member having a first end and a second end, and an outer member having a first end and a second end, wherein the flange of the threaded member is in contact to the inner member; and (iii.) attaching an end-plate to the first end of the inner member and the first end of the outer member; wherein the end-plate includes a joist tab and fastener tabs having openings, wherein the opening has a diameter to hold a fastener in place prior to installation.

After assembling the bracket assembly, the method of installation of the ceiling mounted brace for an electrical fixture continues by (b.) aligning a bracket assembly with a support structure in a ceiling which includes; (i.) inserting a fastener into a pre-set opening of the fastener tabs; (ii) adjusting the telescoping tubular member so as to contact the end-plate and a support; and (iii) aligning the joist tab with a support structure in a ceiling.

The method is completed by (c.) fastening the bracket assembly to a support structure in a ceiling.

### BRIEF DESCRIPTION OF THE DRAWINGS

FIG. 1 is a perspective bottom-view of an exemplary embodiment of the ceiling mounted brace for an electrical fixture of the present invention;

FIG. 2A is an exploded bottom-view of an exemplary embodiment of the electrical junction box shown in FIG. 1;

FIG. 2B is a partially exploded top-view of an exemplary embodiment of the electrical junction box shown in FIG. 1;

FIG. 3A is a perspective bottom view of an exemplary embodiment of the clamping mechanism shown in FIGS. 1, 2A, and 2B;

FIG. 3B is a bottom-view of an exemplary embodiment of the clamping mechanism shown in FIGS. 1, 2A, and 2B;

FIG. 3C is a top-view of an exemplary embodiment of the clamping mechanism shown in FIGS. 1, 2A, and 2B;

FIG. 4A is a perspective view of the end-plate of FIG. 1;

FIG. 4B is a top-view of an exemplary embodiment of the end-plate shown in FIG. 1, shown in contact with a support structure;

FIG. 4C is a top-view of a variation of the embodiment of FIG. 1, of the end-plate shown in contact with a support structure;

FIG. 5 is a front view of an exemplary embodiment of an overlay for an alternative embodiment of the end-plate of the ceiling mounted brace for an electrical fixture of the present invention shown in FIG. 4C;

FIG. 6A is a side view of an exemplary embodiment of a shoulder washer for the alternative embodiment of the end-plate of the ceiling mounted brace for an electrical fixture of the present invention shown in FIG. 4C;

FIG. 6B is a perspective view of the exemplary embodiment of the shoulder washer shown in FIG. 6A;

FIG. 7 is a cross-sectional view along the line 7-7 of the brace of FIG. 1;

FIG. 7A is a cross-sectional view of a variation of the alignment of the spacer illustrated in FIG. 7;

FIG. 8 is a cross-section of another embodiment of the invention illustrating the direct contact of the electrical box to a support member; and

FIG. 8A is an enlarged view of a designated section of FIG. 8.

### DETAILED DESCRIPTION OF THE INVENTION

Certain terminology is used herein for convenience only and is not to be taken as a limitation on the present invention. The words “right,” “left,” “outwardly” and “inwardly” designate directions in the drawings to which reference is made. The words “proximal” and “distal” refer to directions away from and closer to, respectively, the central portion of the assembly according to the present invention. The terminology includes the words above specifically mentioned, derivatives thereof, and words of similar import.

In a first embodiment, the invention is directed to a ceiling mounted brace bracket assembly means for securing an electrical fixture. The assembly means includes an electrical current connecting means, most commonly a standard electrical junction box, and a spacer means secured to the electrical current connecting means. An adjusting means which has the ability to extend and retract, so as to contact a support structure for mounting bracket assembly, is in contact with the spacer means and electrical current connector means. The contact is designed so the adjusting means receives the entire weight (load) of the fixture to be mounted. A securing means is attached to the adjusting means for attachment to a support structure. A means for holding a bracket fastening means is included on the securing means for attachment to a support structure, by a bracket fastening means for securing the bracket assembly means to a structure. The bracket fastening means for securing the bracket assembly means to a support structure is held in position by the means for holding a bracket fastener prior to securing to a support structure.

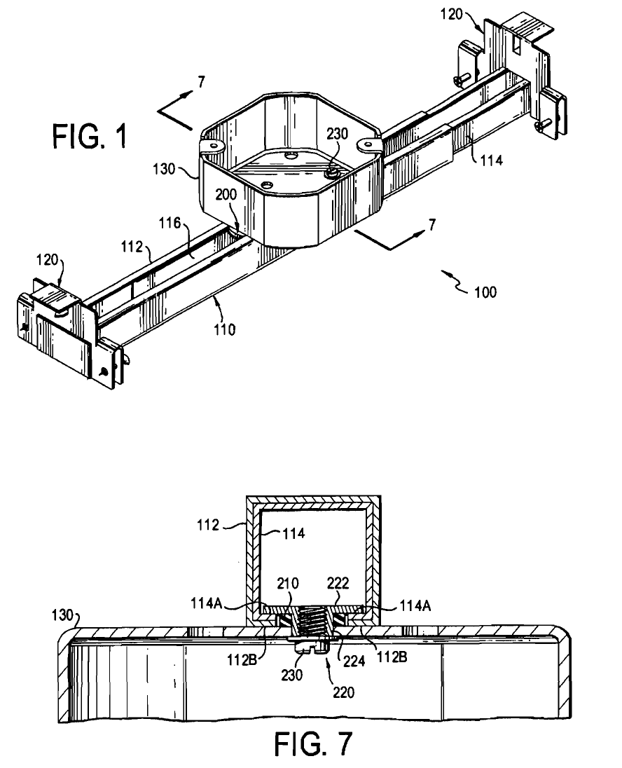

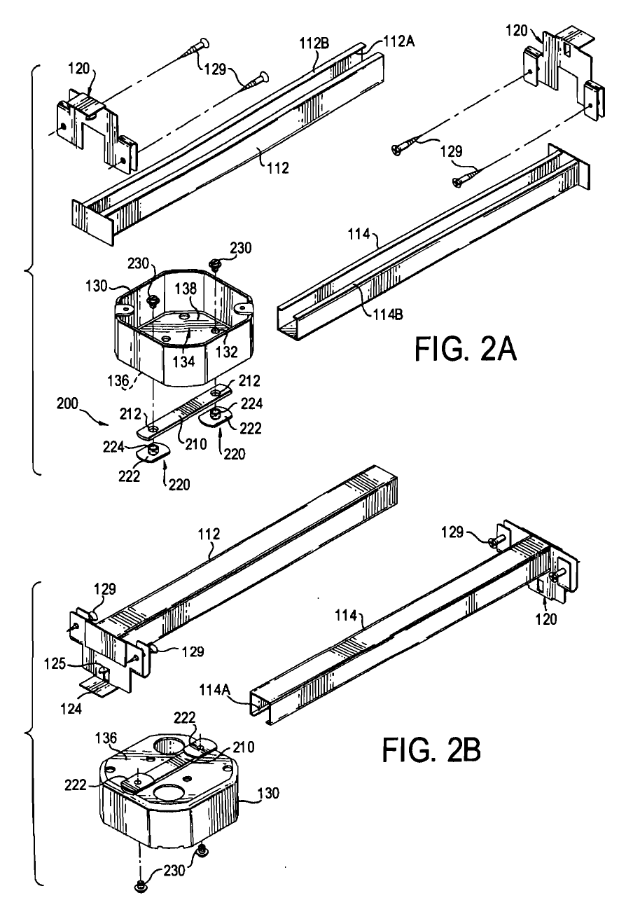

In an exemplary embodiment illustrated in FIGS. 1, 2A, and 2B, the mounting bracket assembly 100 includes a telescoping tubular bar mechanism 110, end-plates 120 at each end of the telescoping tubular bar mechanism 110, and a metal electrical junction box 130 attached to the telescoping tubular bar mechanism 110. The electrical junction box 130 alternatively may include a plastic cover (not shown). The telescoping tubular bar mechanism 110 includes an outer member 112 and an inner member 114. The diameter of the inner member 114 is smaller than the diameter of the outer member 112 to allow the inner member 114 to slide inside the outer member 112, thereby producing the telescoping nature of the tubular bar mechanism 110.

A clamping mechanism 200 attaches the electrical junction box 130 to the telescoping tubular bar mechanism 110. The clamping mechanism 200 slides inside the telescoping tubular bar mechanism 110 along an inner groove 114A that runs the length of the lateral axis of the inner member 114. An outer groove 114B contacts an inner member 112A of the outer member 112 upon insertion of the inner member 114 within the outer member 112.

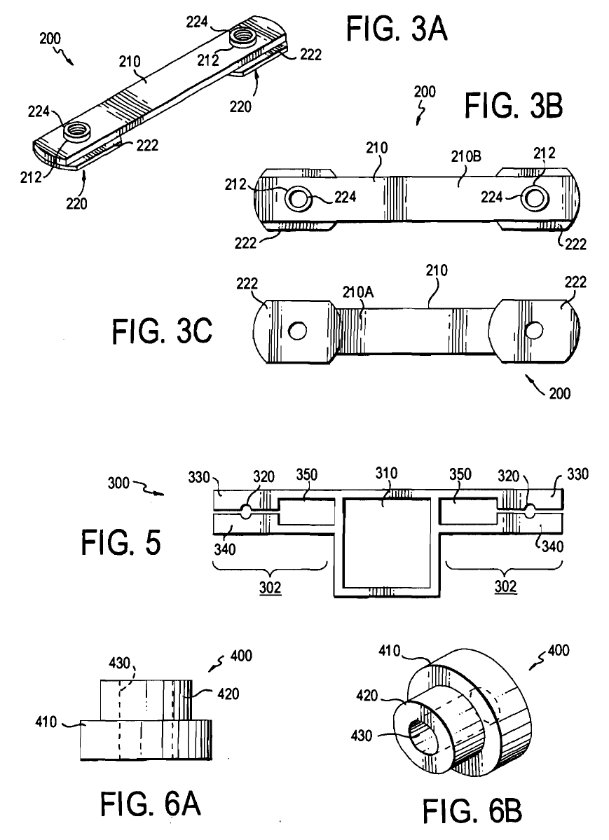

Referring to FIGS. 3A, 3B and 3C, the clamping mechanism 200 includes a spacer member 210 traversed by two threaded members 220. The spacer member 210 is constructed of a material that is rigid, or pliable, e.g. thin metal, rubber or plastic. The threaded members 220 are most commonly barrel nuts or flanged rivets. Each threaded member 220 includes a flange 222 and a protruding boss 224. Threads on the protruding boss 224 extend the entire length of the protruding boss 224 so as to support the greatest amount of load possible. It is recognized by those skilled in the art that the protruding boss 224 can be internally threaded or externally threaded. Two threaded members 220 are laterally positioned along the spacer member 210. It will be recognized by those skilled in the art that the clamping mechanism 200 can include more than two laterally spaced threaded members.

Referring to FIGS. 2A and 2B, the protruding boss 224 passes through the openings 212 in the spacer member 210 such that the flange 222 rests on a first surface of the spacer member 210A (as best illustrated in FIG. 3C). The protruding boss 224 passes through openings 132 in the upper wall 134 of the electrical junction box 130 such that a second surface 210B (as best illustrated FIG. 3B) of the spacer member 210 is in contact with the outer surface 136 of the upper wall 134 of the electrical junction box 130. The openings 212 in the spacer member 210 are placed so as to align with the opening 132 of the upper wall 134 of the electrical box 130. Fasteners 230 attach to the protruding boss 224 such that the fasteners 230 contact the inner surface 138 of the upper wall 134 of the electrical junction box 130. Fasteners 230 pass through the openings 132 in the upper wall 134 of the electrical junction box 130 and into threaded members 220 in the clamping mechanism 200, so as to allow contact of the outer surface 136 of the upper wall 134 of the electrical junction box 130 to an outer surface 112B of the outer member 112 of the telescoping tubular bar mechanism 110.

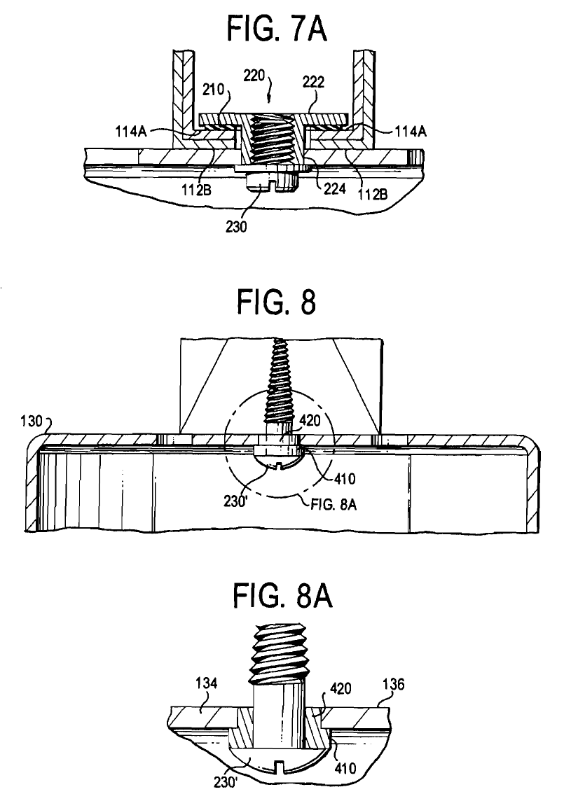

As best illustrated in FIG. 7, the width of the flange 222 exceeds the width of the spacer 210 thereby allowing the distal portion of the width of the flange 222 to overlap the spacer 210. This overlapping portion of the width of the flange 222 contacts the inner groove 114A of the inner member 114 of the tubular bar mechanism 110. This alignment of the electrical junction box 130, telescoping members 112, 114 and clamping mechanism 200, distributes the load from the electrical junction box 130 to the telescoping tubular bar mechanism 110. Prior to installation, it should be recognized that the box 130 could be position anywhere along the inner groove 114A of the inner member 114 or the inner groove 112A of the outer member (when extended) based upon location of the support structures.

As illustrated in FIG. 7A, it is recognized by those skilled in the art, the spacer 210 could be positioned within the inner member 114 of the tubular bar mechanism 110. In this alignment, the spacer 210 would be compressed between flange 222 and the inner member 114 of the tubular bar mechanism 110 upon installation. This variation, from the alignment in FIG. 7, would not effect the entire load distribution of the fixture to be distributed to the tubular bar mechanism 110.

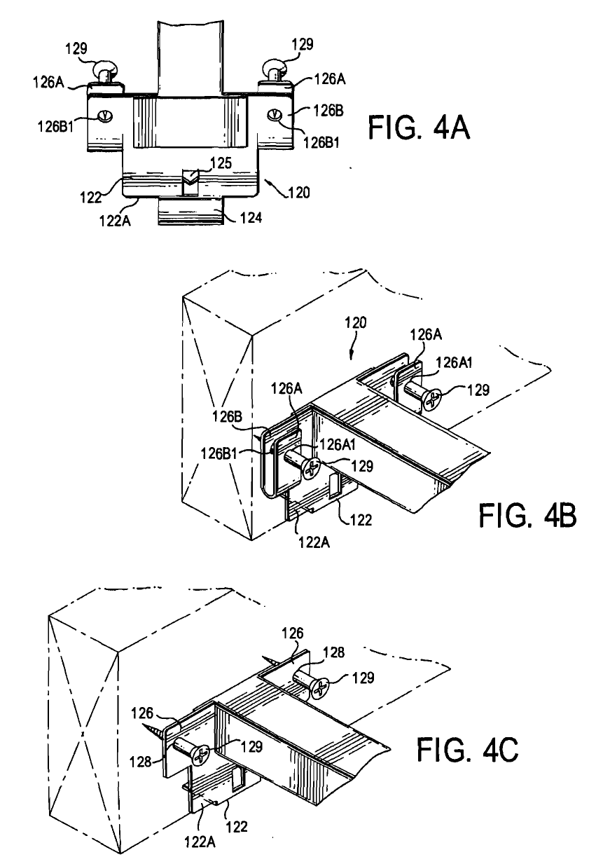

Referring to FIGS. 4A and 4B, the end-plate 120 is connected to the inner member 114 and outer member 112 of the telescoping tubular bar mechanism 110 at its body 122. The attachment can be a weld, rivet or the like. However, it will be recognized by those skilled in the art that attachment of the end-plate 120 and the inner member 114 and/or to outer member 112 can be of a single-piece construction. The end-plate 120 includes a joist tab 124 on the lower edge 122A of the end-plate body 122, wherein the joist tab 124 is perpendicular to the end-plate body 122.

Referring to FIGS. 1, 2A, 2B, 4A and 4B, fastener tabs 126 are attached at both sides of the end plate body 122 configured in a U-shaped tab folded in half along a horizontal line, wherein a first portion 126A of the U-shaped tab is folded over a second portion 126B of the U-shaped tab, and the length of the first portion 126A is approximately equal to the length of the second portion 126B. The first portion of the U-shaped tab 126A includes a first opening 126A1 that is horizontally aligned with a second opening 126B1 in the second portion 126B of the U-shaped tab 126. The diameter of the first opening 126A1 is such that it will hold a fastener 129 in place and aligned with the second opening 126B1 so the installer can insert the fastener 129 with one hand (i.e., a preset fastener). This design allows an installer to insert the fastener 129 without the need to hold the fastener 129 with one hand and a tool for inserting the fastener 129 with the other hand. However, it is not required that the length of the first portion 126A and the length of the second portion 126B be equal. It is only required that the openings 126A1 and 126B1 be aligned to allow the fastener 129 to traverse the openings 126A1 and 126B1 for installation on a support structure.

Referring to FIGS. 4B and 4C, an installer of the ceiling mounted brace 100 places the joist tab 124 on a lower surface of the joist or beam (shown in phantom) to position the electrical junction box 130 at an appropriate height for the finished ceiling. Additionally, as best illustrated in FIG. 2B, an impaling projection 125 extends from the end plate body 122 proximate the joist tab 124 to initially hold the brace 100 in place prior to being secured via fasteners.

Referring to FIG. 4C, in a variation of the end plate illustrated in FIGS. 4A and 4B, the fastener tabs 126 on the left and right side of the end-plate body 122 have a single plane. The fastener tabs 126 have surface planes that are parallel to a surface plane of the end-plate body 122. The fastener tabs 126 each include a single opening 128 that receive fasteners 129, such as a screw, nail, or the like, to mount the end-plate 120 on a joist, beam, or the like.

Referring to FIG. 5, the ceiling mounted brace for an electrical fixture 100 includes an overlay 300 of the end-plate 120. This overlay is used in conjunction with the end plate embodiment of FIG. 4C. The inner member 114 and outer member 112 of the telescoping tubular bar mechanism 110 slides through a cutout 310 in the overlay 300 allowing the overlay 300 to rest against an inner surface of the end-plate 120. The overlay 300 includes tabs 302 on the left and right side of the cutout 310, wherein each tab 302 includes an upper 330 and lower 340 finger. Each finger includes a semicircular cutout 320 for holding a fastener (not shown) in a preset position and aligned with the opening 128 of the fastener tabs 126 in the end-plate 120. The fingers 330, 340 pivot along a horizontal line through each tab 302. Each tab 302 includes a hinge cutout 350 proximate to the cutout 310. The hinge cutout 350 in the tab 302 is the pivot point for each finger 330, 340. It is recognized by those skilled in the art, the size and shape of the hinge cutout 350 in the tab varies to create more or less tension between the fingers 330, 340 to hold a fastener in a preset position. The overlay 300 is constructed of a material that is rigid, stiff, flexible, or pliable, e.g. plastic.

After installing the mounting brace 100 by tightening the preset fasteners 129, the overlay 300 remains in place but is not sandwiched between the end-plate 120 and the fastener 129. In a variation, the overlay 300 remains in place and is sandwiched between the end-plate 120 and the fastener 129. Thus, contact of the “head” of the fastener 129 can be with the overlay 300 or the end-plate 120.

A shoulder washer as shown in FIGS. 6A and 6B, can be inserted into the opening 128 in the embodiment of the end-plate 120 illustrated in FIG. 4C, wherein no overlay 300 is used. The shoulder washer 400 includes a flange 410 and a protruding boss 420. The flange 410 rests against the inner surface plane of the end-plate 120 with the protruding boss 420 inserted into the opening 128 in the fastener tab 126. The protruding boss 420 includes an opening 430 through its center and along a lateral axis, wherein the diameter of the opening 430 through the boss 420 is appropriate to hold a fastener (not shown) in a preset position. In various embodiments, the shoulder washer is constructed of a material that is rigid, most commonly a plastic.

Referring to FIGS. 8 and 8A, in another embodiment, it is appreciated that the shoulder washers as described herein can be inserted into any openings in the upper wall 134 (as illustrated in FIGS. 1 and 8) of a commercially available standard electrical junction box 130 for direct attachment to a support structure. The shoulder washer 400 is configured to have the protruding boss 420 extend one-sixteenth of an inch from the flange 430 to approximate the thickness of the upper wall 134 of the box 130 while being flush with the external surface 136 of the electrical box 130. The diameter of the flange 410 is such that is will not traverse the opening 132 in the upper wall 134 and will rest against the inner surface 138 of the upper wall 134. The protruding boss 420, which will be inserted, holds a fastener 129 in a preset position to assist the installer with attaching the electrical junction box 130 directly to a beam, joist or a cross-member between two beams, without the necessity of the clamping mechanism 200, telescoping bar mechanism 110 or end plates 120. Referring to FIG. 8A, the protruding boss 420 is illustrated flush with the outer surface 136 of the upper wall 134 of the electrical box 130 allowing the direct contact with the support member. The design of the shoulder washer 400 allows attachment of a fastener 129 prior to insertion in the openings 132 of a standard junction box 130 to accomplish “one-handed” installation, e.g. one hand is necessary to attach the box to the support structure (the other hand can be used to hold the box in position). Further, the design of the shoulder washer 400 is unique in that while installing the box 130, the fastener 129 in traversing the opening 430 expands the protruding boss 420 to secure the fit of the fastener 129 with the opening 132 of the box 130. The protruding boss 420 of the shoulder washer 400 substantially breaks apart in the opening 132 of the box 130. Likewise, it will be recognized the protruding boss 420 of the shoulder washer 400 substantially breaks apart in the opening 128 of the end-plate 126, if used in the embodiment of FIG. 4C without an overlay 300 (as discussed herein).

In another embodiment the invention is directed to a method for installing a ceiling mounted brace for an electrical fixture (described herein). The method includes the steps of (a) assembling a bracket assembly by; (i.) attaching a substantially rectangular plate member having a defined width and length, to an electrical box, wherein the plate member is attached by at least one threaded member which traverses the end-plate and the electrical box. The threaded member includes a flange and protruding member, wherein the flange extends beyond the width of the plate member. Thereafter, assembling the bracket continues by; (ii.) attaching the flange of the threaded member to a telescoping tubular member, wherein the telescoping tubular member has an inner member having a first end and a second end, and an outer member having a first end and a second end, wherein the flange of the threaded member is in contact to the inner member; and (iii.) attaching an end-plate to the first end of the inner member and the first end of the outer member; wherein the end-plate comprises a joist tab and fastener tabs having openings, wherein the opening has a diameter to hold a fastener in place.

After assembling the bracket assembly, the method of installation of the ceiling mounted brace for an electrical fixture continues by (b.) aligning a bracket assembly with a support structure in a ceiling which includes; (i.) inserting a fastener into a pre-set opening of the fastener tabs; (ii) adjusting the telescoping tubular member so as to contact the end-plate and a support structure in a ceiling; and (iii) aligning the joist tab with a support structure in a ceiling.

The method is completed by (c.) fastening the bracket assembly to a support structure in a ceiling.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A ceiling mounted brace bracket assembly means for securing an electrical fixture comprising:
an electrical current connecting means;
a spacer means secured to the electrical current connecting means;
an adjusting means in contact with the spacer means;
a securing means attached to the adjusting means;
a means for holding a bracket fastening means; and
a bracket fastening means for securing the bracket to a structure,
wherein the bracket fastening means for securing the bracket assembly means to a structure is held in position prior to installation in a support structure by the means for holding a bracket fastener.

2. A ceiling mounted brace bracket assembly for securing an electrical fixture comprising:
a. a telescoping tubular bar mechanism;
b. an electrical junction box having an upper wall, wherein the upper wall has an inner surface and an outer surface, wherein the box is attached to the telescoping tubular bar; and
c. end-plates at each end of the telescoping tubular bar.

3. The bracket of claim 2, wherein telescoping tubular bar comprises an inner member having a first end and a second end, and an outer member having a first end and a second end, wherein the diameter of the inner member is smaller than the diameter of the outer member, wherein the inner member slides inside the outer member upon attachment.

4. The bracket of claim 3, wherein the bracket further comprises a clamping mechanism attached to the electrical box, wherein the clamping mechanism comprises a longitudinal spacer member having a first surface and a second surface having inlets therethrough, wherein the spacer extends along a mid-line of the outer surface of the upper wall of the electrical box, wherein the clamping member further comprises at least one threaded member, wherein the threaded member comprises a flange and protruding boss, wherein the protruding boss has an interior and exterior surface, wherein the interior surface has threads which extend the length thereof.

5. The bracket of claim 4, wherein the spacer is substantially rectangular in shape having a width and a length, wherein the flange of the at least one threaded member extends outside the width of the spacer.

6. The bracket of claim 5, wherein the protruding boss of the at least one threaded member traverses the spacer and the inner and outer surface of the upper wall of the electrical box; wherein a first surface of the flange of the at least one threaded member is in contact to the inner member of the telescoping bar.

7. The bracket of claim 6, wherein the assembly bracket further comprises boss fasteners, wherein the boss fasteners contact inner surface of the upper wall of the electrical box.

8. The bracket of claim 7, wherein the first end of the inner member and the first end of the outer member of the telescoping tubular bar mechanism are attached to an end-plate.

9. The bracket of claim 8, wherein the end-plate comprises a body section, a joist tab at a lower edge and fastener tabs on a first side of the end-plate body and a second side of the end-plate body, wherein the fastener tabs have openings.

10. The bracket of claim 9, wherein the joist tab is perpendicular to the end-plate body.

11. The bracket of claim 10, wherein the fastener tabs are parallel to the end-plate body and comprise openings, wherein the diameter of the openings will hold a fastener in place.

12. The bracket of claim 9, wherein the fastener tabs are U-shaped forming a first portion and a second portion, wherein the first portion of the U-shaped tab includes a first opening that is horizontally aligned with a second opening in the second portion of the U-shaped tab, wherein the diameter of the first opening is such that it will hold a fastener in place and aligned with the second opening.

13. The bracket of claim 12, wherein first portion and the second portion of the U-shaped fastener tab are of equal length.

14. The bracket of claim 12, wherein first portion and the second portion of the U-shape fastener tab are not of equal length.

15. The bracket of claim 9, wherein an overlay is proximal to the end-plate having cutout in a midsection, wherein the overlay includes a tab on the left and right side of the cutout.

16. The bracket of claim 15, wherein each tab includes an upper and lower finger, wherein each finger includes a semicircular cutout aligned with the opening in the fastener tabs of the end-plate, wherein the fingers pivot along a horizontal line through the tab.

17. The bracket of claim of 16, wherein the tab includes a hinge cutout on the inner portion of the tab proximal to the cutout.

18. The bracket of claim 9, further comprising a shoulder washer comprising a flange and a protruding boss, wherein the protruding boss has a diameter complimentary to the opening in the end plate fastener tabs, wherein the flange contacts the end-plate fastener tabs when the protruding boss is inserted into the opening in the end-plate fastener tabs.

19. The bracket of claim 18, wherein the protruding boss comprises an opening through its center and along a lateral axis, wherein the diameter of the opening through the boss is appropriate to hold a fastener in a preset position.

20. A ceiling mounted brace assembly comprising:
a. a shoulder washer having a flange portion and a protruding boss portion, wherein the shoulder washer holds a fastener in a preset position; and
b. an electrical junction box having an upper wall, wherein the upper wall has an inner surface and an outer surface, wherein the flange of the shoulder washer is in contact with inner surface of the upper wall and the protruding boss is flush with the outer surface of the upper wall,
wherein the protruding boss expands upon being traversed by a fastener.

21. A method for installing a ceiling mounted brace for an electrical fixture comprising the steps of:
a. assembling a bracket assembly comprising the steps of:
i. attaching a substantially rectangular plate member having a defined width and length, to an electrical box, wherein the plate member is attached by at least one threaded member which traverses the end-plate and the electrical box, wherein the threaded member comprises a flange and protruding member, wherein the flange extends beyond the width of the plate member;
ii. attaching the flange of the threaded member to a telescoping tubular member, wherein the telescoping tubular member has an inner member having a first end and a second end and an outer member having a first end and a second end, wherein the flange of the threaded member is in contact to the inner member;
iii. attaching and end-plate to the first end of the inner member and the first end of the outer member; wherein the end-plate comprises a joist tab and fastener tabs having openings, wherein the opening has a diameter to hold a fastener in place;
b. aligning a bracket assembly with a support structure in a ceiling comprising the steps of;
i. inserting a fastener into a pre-set opening of the fastener tabs;
ii. adjusting the telescoping tubular member so as to contact the end-plate and a support structure in a ceiling; and
iii. aligning the joist tab with a support structure in a ceiling; and
c. fastening the bracket assembly to a support structure in a ceiling.
